(19) United States
(12) Patent Application Publication
(10) Pub. No.: US 2004/0134118 A1
(43) Pub. Date: Jul. 15, 2004

(54) Automatic fish hook and method of use

(76) Inventors: James J. Miller, Lafayette, LA (US); Francis E. Charleville IV, Lafayette, LA (US)

Correspondence Address: THE MATTHEWS FIRM, 1900 WEST LOOP SOUTH, SUITE 1800, HOUSTON, TX, 77027-3224, US

(21) Appl. No.: 10/730,431

(22) Filed: Dec. 8, 2003

Related U.S. Application Data
(63) Continuation-in-part of application No. 10/086,600, filed on Feb. 28, 2002.
Application No. 10/086,600 is a continuation of application No. 09/516,720, filed on Mar. 1, 2000, now abandoned.
(60) Provisional application No. 60/122,462, filed on Mar. 1, 1999.

(51) Int. Cl. A01K 83/02; A01K 83/00

(52) U.S. Cl. 43/34

(57) ABSTRACT

An improved automatic setting hook apparatus that deploys upon the application of generally opposing, lateral, inward forces generated by the inside of a fish's mouth. The apparatus may be manually placed in a cocked position and then released or set upon the application of the two opposing, lateral, inward forces such that a fish may be hooked without the necessity of a fisherman manually setting the hook in the fish's mouth. One embodiment may be an automatic setting hook apparatus comprising a single wire with at least one integral catch.

### RELATED APPLICATION

This application claims priority from U.S. Provisional Patent Application Ser. No. 60/122,462 having a filing date of Mar. 1, 1999. Further, this application is a continuation in part of U.S. patent application Ser. No. 10/086,600 having a filing date of Feb. 28, 2002 which is a continuation of U.S. patent application Ser. No. 09/516,720, having a filing date of Mar. 1, 2000.

### TECHNICAL FIELD

The present invention relates generally to an apparatus that may be used to catch fish. More particularly, the present invention relates to fish hooks and more particularly to an improved automatic fish hook and method of use.

### BACKGROUND ART

Fishing over the years has changed from a necessity of survival to mainly sport and pleasure for a portion of the population. As fishing has developed, the type, quantity and specificity of the equipment used by the fisherman has also changed.

Most sport and pleasure fishing is accomplished by way of a hook and a line cast from a rod. However, the variety of this equipment available to a fisherman is extensive. There are numerous rod, reel and line combinations available for the fisherman to choose from. Each type or selection is advertised to be suited for a particular type of fish or a particular type of environment. Moreover, the choice of the proper rod and reel combination, or rig as a fisherman might refer to it, directly effects a fisherman's probability of catching fish.

Beyond the rod and reel combinations, the variety and types of hooks a fisherman may choose from is tremendous. Hooks exist that are single pointed, double pointed, triple pointed and so on, with barbs, without barbs and multiple barbs. However, the majority of the prior art hooks share one characteristic. That characteristic being that the point is shaped from a metal shank with an eyelet on one end and the point and/or barb on the other end. This arrangement may be commonly referred to as a hook.

Fishing has developed such that a bait or lure of some type may be placed about the point end of the hook. The hook may then be cast or placed into the water. When a fisherman feels or observes something, hopefully a fish attempting to remove the bait, the fisherman sets the hook. Setting the hook requires the fisherman to move the line attached to the hook so that the hook would catch the fish by contacting the fish with a point of the hook.

The proper setting of the hook is perhaps the most difficult part of fishing to learn. It is often regarded as the most difficult part of fishing because different types of fish require different movements and forces to properly set the hook. Unfortunately, many fish are not caught because the hook is not set properly.

There have been attempts in the prior art to solve this problem. One such attempt is disclosed in U.S. Pat. No. 5,890,314 entitled Self-Setting Hook Configuration for Weedless Fishing Lures. In that patent, a spring biased dual hook assembly is disclosed that is activated when either the fisherman or the fish pulls on the apparatus. The releasable apparatus disclosed by the patent is deployed only by the fish or fisherman applying force against the line. Accordingly, this self-setting hook is sometimes not self-setting at all, but rather requires a pulling movement of the line to provide a tension upon the hook and deploying of the spring. For example, if the assembly is inside the fish mouth and the fish swims toward the fisherman, the hook will not set.

Still other prior art patents disclose self-setting spring biased dual hook assemblies with a non-integral latch assembly to maintain the spring bias. In order to set such hook assemblies, pressure must first be exerted in a direction to increase the spring bias in order to unload the latching pressure. Next an additional pressure must be exerted laterally against the latched hook in order for the hook to spring away from the latch. Thus, these assemblies are also not really self-setting in that if a fish does not exert the proper pressures, such as basically chewing or otherwise manipulating the hook assemblies with its mouth, the hooks may not set without some external pull by the fisherman. Further, some of these hook assemblies do not have the weedless feature in that the hooks project outwardly and do not obscure each other. Thus, weeds and other debris can become entangled in the hook assembly.

Accordingly, it is an object of the present invention to provide an improved automatic and weedless hook apparatus.

### SUMMARY

By way of example, the description of the invention that follows will be given in relation to an automatic fish hook However, those of ordinary skill in the art will readily see that the invention may be used for a wide variety of functions. The disclosure that follows is not meant to limit the scope of the invention.

An embodiment of the present invention generally relates to a fishing hook designed to automatically set in a fish's mouth. The closing of the fish's mouth produces two generally opposing, lateral, inward forces sufficient to automatically set the hook. Therefore, it is not necessary for either the fish or the fisherman to exert any pulling force on the fishing line to set the hook. It is further unnecessary for the fish to manipulate the hook assembly, in its mouth, to cause the hook assembly to set.

In one embodiment of the invention, the automatic hook is comprised of two hooks extending about a coil with a notch along the coil. The coil tends to keep the hooks biased in a certain direction.

As a feature of this embodiment, the tensioner coil that may be adjusted to effectuate the angle of the bias of the hooks from the coil. The tensioner may be releasable secured in a notch such that two generally opposing, lateral, inward forces are required to release the bias along the hooks. In another embodiment, the automatic hook is made from a single wire including an integral catch mechanism. In this embodiment, releasing the hooks through the generally opposing, lateral, inward forces caused by opposing sides of the fish mouth tends to cause the hooks to return to their open position. In this open position the hooks are facing away from one another and will thus preferably penetrate two sides of fish's mouth; thus catching the fish on the hooks.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 is an illustration of an embodiment of the present invention disassembled into its component pieces.

FIG. 2 is an illustration of the assembled embodiment of FIG. 1 in which the bias on the tensioner is relaxed.

FIG. 3 is an illustration of the embodiment of FIG. 2 in which the bias on the tensioner is not relaxed.

FIG. 4 is an illustration of a perspective end view of the embodiment of FIG. 2.

FIG. 5 is an illustration of an alternative embodiment of the present invention, in the open or set position, wherein the apparatus is formed from a single wire.

FIG. 6 is an illustration of the embodiment of FIG. 5 in a cocked position.

FIG. 6A is an illustration of a perspective end view of the embodiment of FIG. 6.

FIG. 6B is an illustration of another view of the embodiment of FIG. 6 showing the shanks obscuring the hooks.

FIG. 6C is an illustration of another view of the embodiment of FIG. 6 showing the automatic hook in a mis-set position.

FIG. 7 is an illustration of an embodiment in a set position further illustrating barbs on the hooks.

FIG. 7A is an illustration of an embodiment in a set position further illustrating an alternative catch mechanism.

FIG. 7B is an illustration of the embodiment of FIG. 7 in a cocked position.

FIG. 7C is an illustration of an embodiment in illustrating another alternative catch mechanism.

FIG. 8 is an illustration of an embodiment of the present invention, with the automatic hook in the set position, at use in an aquatic environment.

FIG. 9 is an illustration of an embodiment of the present invention, with the automatic hook in the cocked position, at use in an aquatic environment.

FIG. 10 is an illustration of an embodiment of the present invention, with the automatic hook in the set position, at use in an aquatic environment.

### GENERAL DESCRIPTION AND PREFERRED MODE FOR CARRYING OUT THE INVENTION

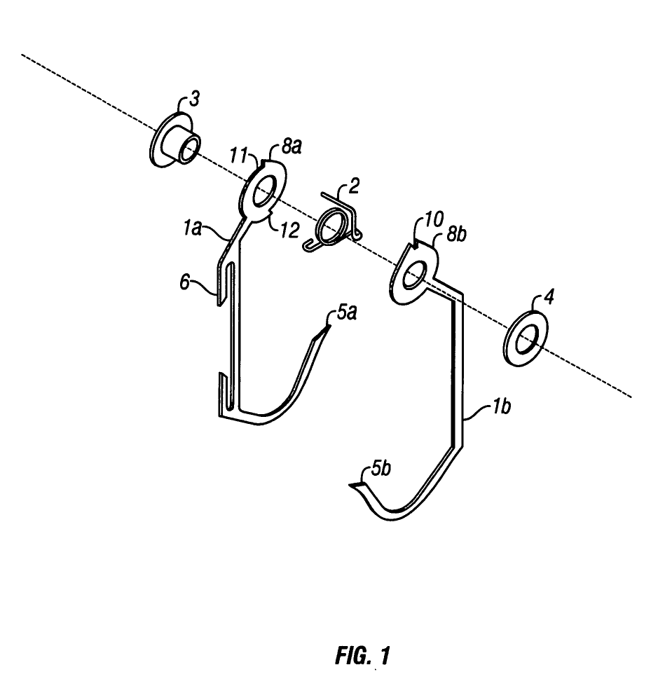

Referring now to FIG. 1, an illustration of an embodiment of the present invention disassembled into this embodiment's component pieces. The present invention envisions several components in one embodiment. However, other embodiments of the invention envision a single piece of material configured into the present invention. In a multi piece preferred embodiment, during assembly, shank 1a and shank 1b are arranged such that point 5a and point 5b are adjacent one another. Then flange 8a and flange 8b are aligned such that tensioner 2 is placed between flange 8a and flange 8b.

Next a hollow bore brad backing 3 may be inserted through flange 8a, through tensioner 2, and through flange 8b while keeping the general orientation of shank 1a and shank 1b. In this embodiment, tensioner 2 is then arranged such that a portion of tensioner 2 may be placed in angled slot 10 on flange 8b. Hollow bore brad retainer 4 is then applied to hollow bore brad backing 3 to complete assembly of the apparatus. It should be appreciated by those skilled in the art that the brad an brad retainer are preferably hollow for an attachment point for the end of the fishing line. Because the embodiments of the present invention are self-setting and thus do not require any pull or tug on the line by either the fisherman or the fish, the fishing line can be attached to any convenient point, such as a hollow brad and retainer.

In this embodiment, flange 8a has an upper cam 11 and a reverse angle cam 12. When the tensioner 2 is assembled in this embodiment, reverse angle cam 12 may act as a mechanical stop to prevent over rotation of tensioner 2. It may be noted that in this embodiment, shank 1a or shank 1b may have an prong 6 that may be used to attach a body of a lure, worm, bait, or other desired items. Prong 6 may be a folded clip or simply an abutment of the member to provide an area for attaching the desired items.

FIG. 1, further illustrates an embodiment of the present invention with a single pointed member on point 5a and point 5b. However the invention contemplates the use of multiple points. The invention also contemplates the use of a barb disposed about point 5a and/or point 5b. It may also be evident to those of ordinary skill in the art that point 5a and point 5b may be any shape common in the art such as straight, bent, twisted or hooked. Still further, the embodiment in FIG. 1, illustrates a common orientation of a hook. However, the invention contemplates other orientations common in the art such as straight, bent, twisted, and others.

The choice of materials for embodiments of the present invention is not limited to any particular material. However, common examples would include, but not be limited to, steel, iron, aluminum, copper, an alloy of steel, an alloy of iron, an alloy of aluminum, an alloy of copper and combinations thereof. Additionally, the present invention may be constructed of a composite material, a plastic, such as polyvinyl chloride, or any variety of synthetic materials which allow for the necessary rigidity to support the features and functions of the present device.

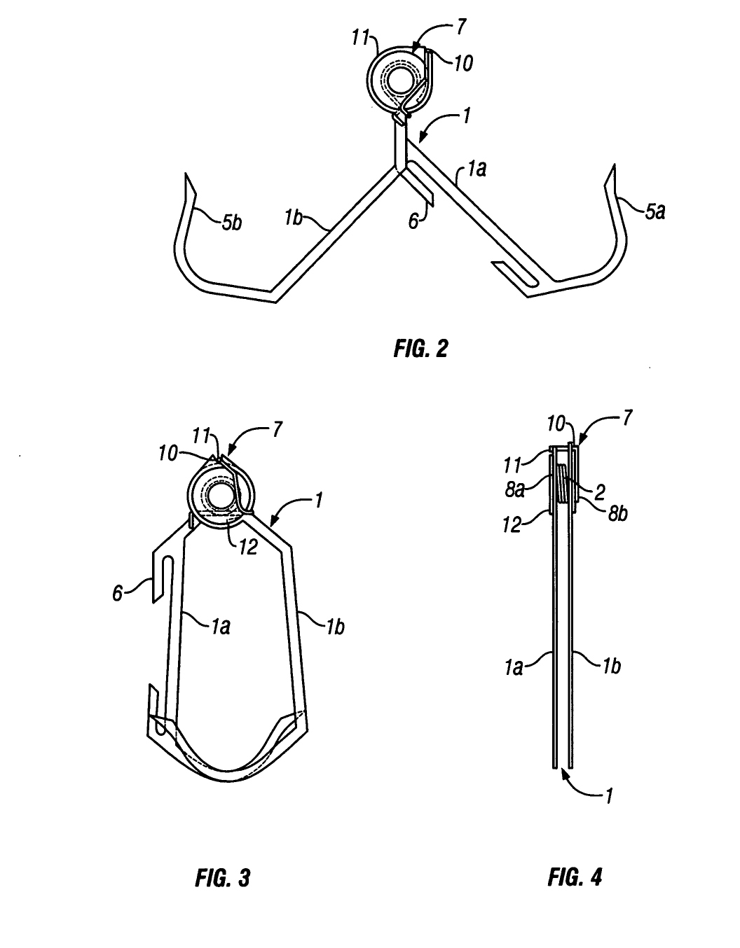

Referring now to FIG. 2, an illustration of an embodiment of the present invention in which the bias on tensioner 2 is relaxed and not in the cocked or prepared position, it may be observed that tensioner assembly 7 preferably biases a shank 1a and shank 1b such that point 5a and point 5b are in directions generally opposed to the other. Tensioner assembly 7 may include tensioner 2, flange 8a, flange 8b, hollow bore brad backing 3, hollow bore brad retainer 4, slot 10, upper cam 11, and reverse cam 12. To cock or prepare this embodiment of the present invention for fishing, a user will preferably apply a generally opposing, lateral, inward force on shank 1a and a generally opposing, lateral, inward force on shank 1b to place shank 1a and shank 1b in position where upper cam 11 is adjacent to angled slot 10 so tensioner 2 may extend across upper cam 11. Extending tensioner 2 across upper cam 11 provides resistance to the centrifugal force created along tensioner 2 by the application of the opposing forces in preparing the apparatus for use by placing the apparatus in the cocked position.

This embodiment, of the present invention, may releasably remain in the cocked position illustrated in FIG. 3. FIG. 3 is an illustration of an embodiment of the present invention in which the bias on the tensioner is not relaxed until a lateral, inward force acts upon shank 1a towards a generally opposed lateral, inward force acting upon shank 1b. In use, the generally opposing, lateral, inward forces are supplied by the interior of the mouth and/or throat of a fish. Upon the application of the forces sufficient to overcome the resistance created by upper cam 11 on tensioner 2, the apparatus may return to the uncocked position as described in FIG. 2. In returning to the uncocked position, this embodiment may expose point 5a and point 5b.

It should be appreciated that the preferred method of uncocking or setting the automatic hook apparatus is through the force supplied by the interior of the fish's mouth. However, it is possible for the fish to sufficiently swallow the automatic hook apparatus wherein the apparatus reaches the fish's throat area and the force supplied by the fish sets or uncocks the automatic hook apparatus inside the fish's throat area.

Referring now to FIG. 3, an illustration of another embodiment of the present invention in which the bias on the tensioner 2 is not relaxed. Shank 1a and shank 1b will be held in this cocked position by tensioner 2 and upper cam 11 with reverse cam 12 as a mechanical stop to prevent over rotation of tensioner mechanism 7. This cocked position in this embodiment is preferably the orientation for use.

It will be apparent to those of skill in the art that the preferred embodiment of the present invention as illustrated by FIG. 3 may have shank 1a and shank 1b disposed parallel such that point 5a and point 5b are partially obscured thereby reducing the frequency in which point 5a or point 5b may become hooked or in direct contact with unintentional items such as algae, seaweed, trees, rocks and the like.

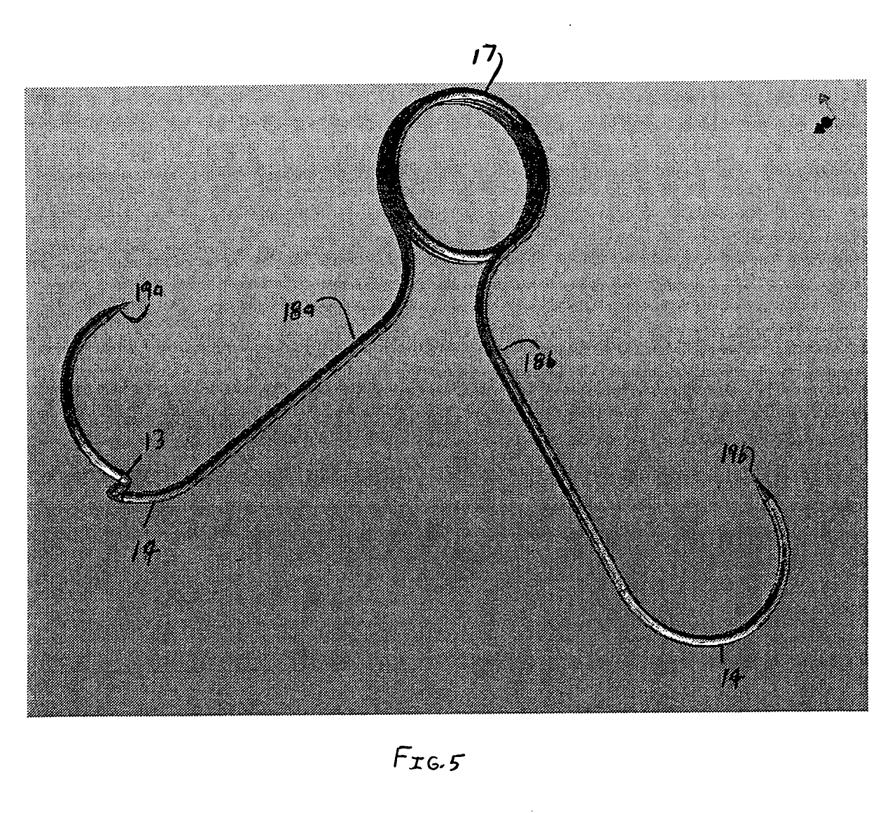

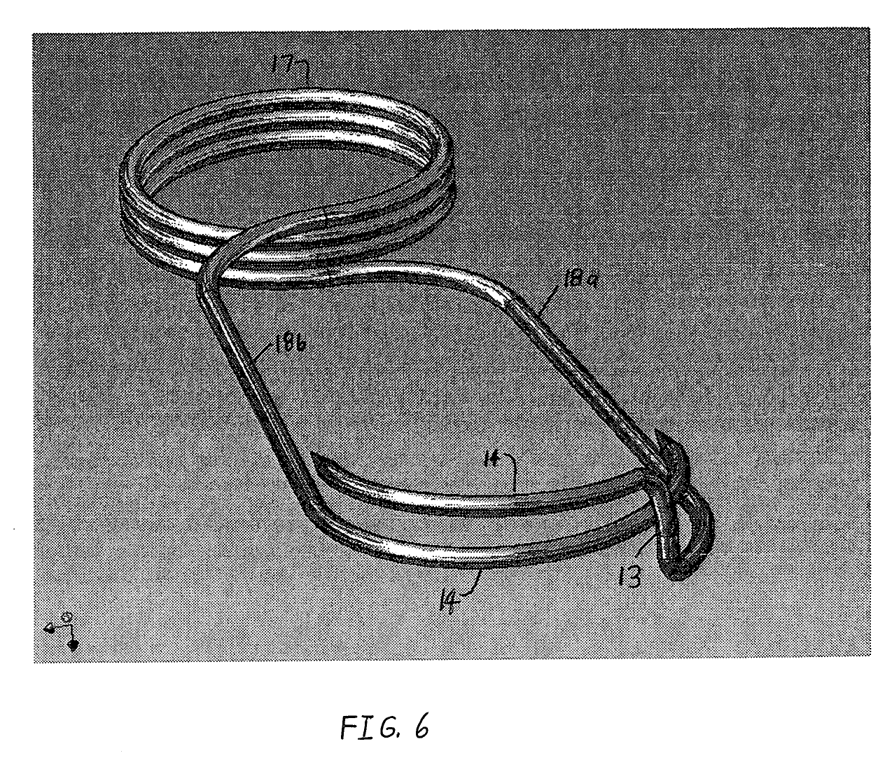

Referring now to FIG. 4, an illustration of a perspective, side view of the device of FIG. 2. In this embodiment, of the present invention, shank 1a and shank 1b are not in contact. Tensioner 2 is arranged between flange 8a and flange 8b. FIG. 4 illustrates a cocked position. Tensioner assembly 7 is set by tensioner 2 extending across angled slot 10 and upper cam 11 with a mechanical stop in reverse cam 12.

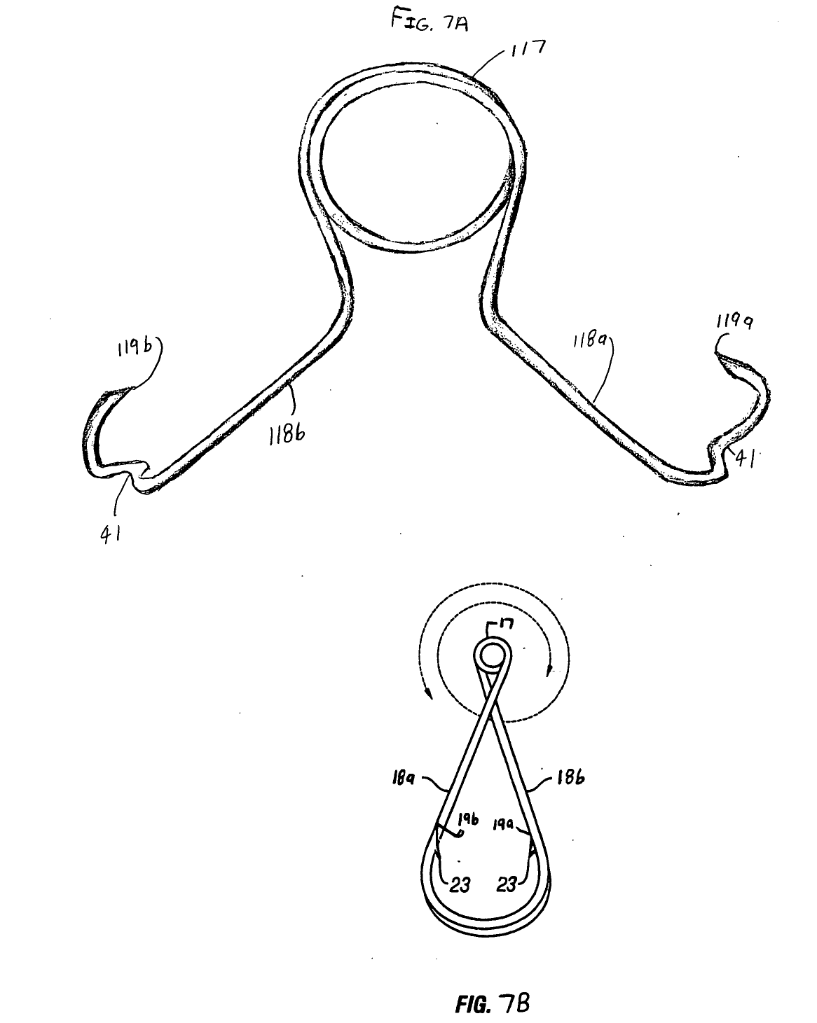

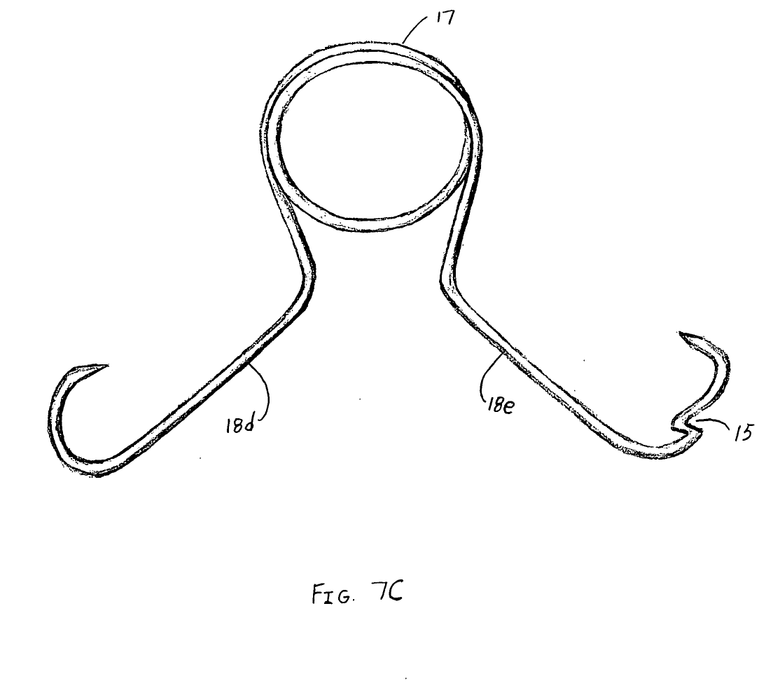

Referring now to FIG. 5, an illustration of an embodiment, of the present invention, wherein the apparatus is formed from a single wire. It should be noted that this embodiment differs from prior art “single wire” hooks inter alia in that the latching mechanism or the catch 13 is integral to the single wire. Therefore, no additional catch, latch, or latch assembly is required to allow the hook to be placed in a set position. However, as described herein below, it should be appreciated that an embodiment with a catch integral to both shanks is within the spirit of this invention (see FIG. 7A).

About the middle of the single wire, the wire is preferably coiled a sufficient number of times to provide adequate bias. The embodiment illustrated in FIG. 5 utilizes two coils in tensioner mechanism or coil 17. However, it should be appreciated that the number of coils can vary depending on the material used for the wire, the fish being targeted, the desired tension of the hooks in the cocked position, and various other factors relating to the fishing experience.

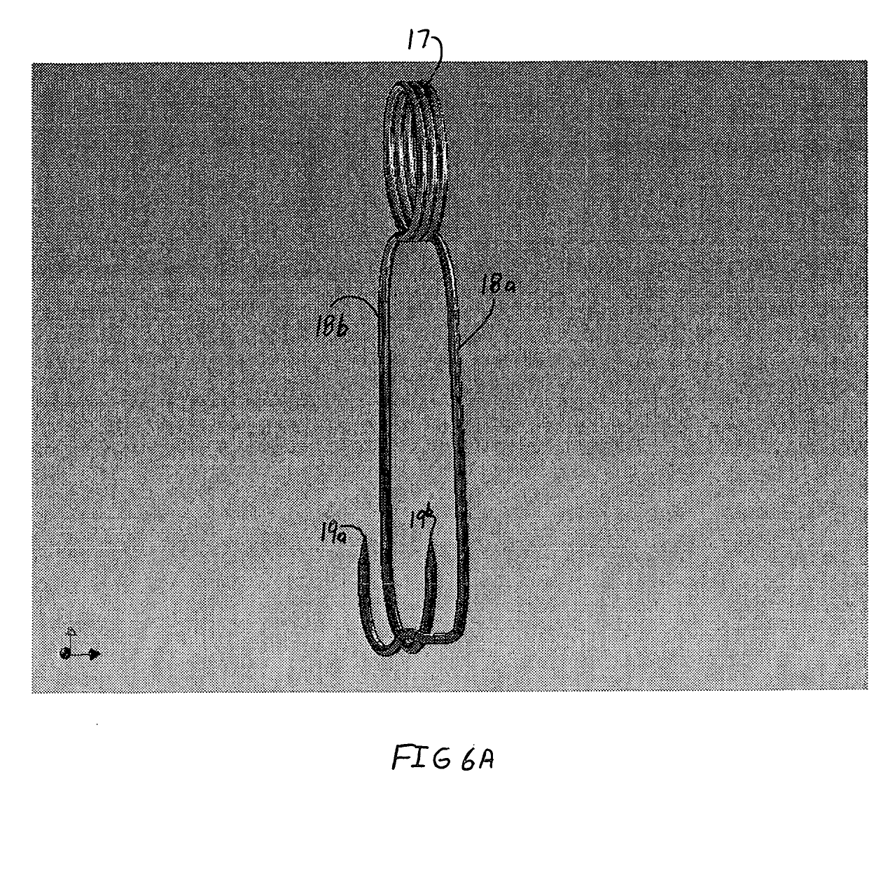

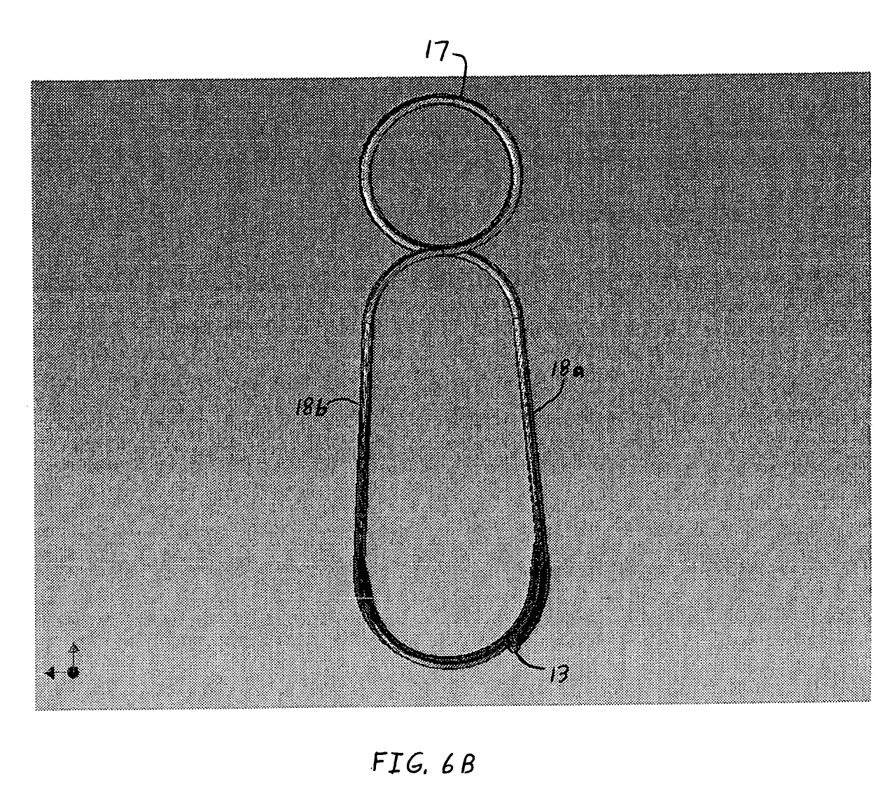

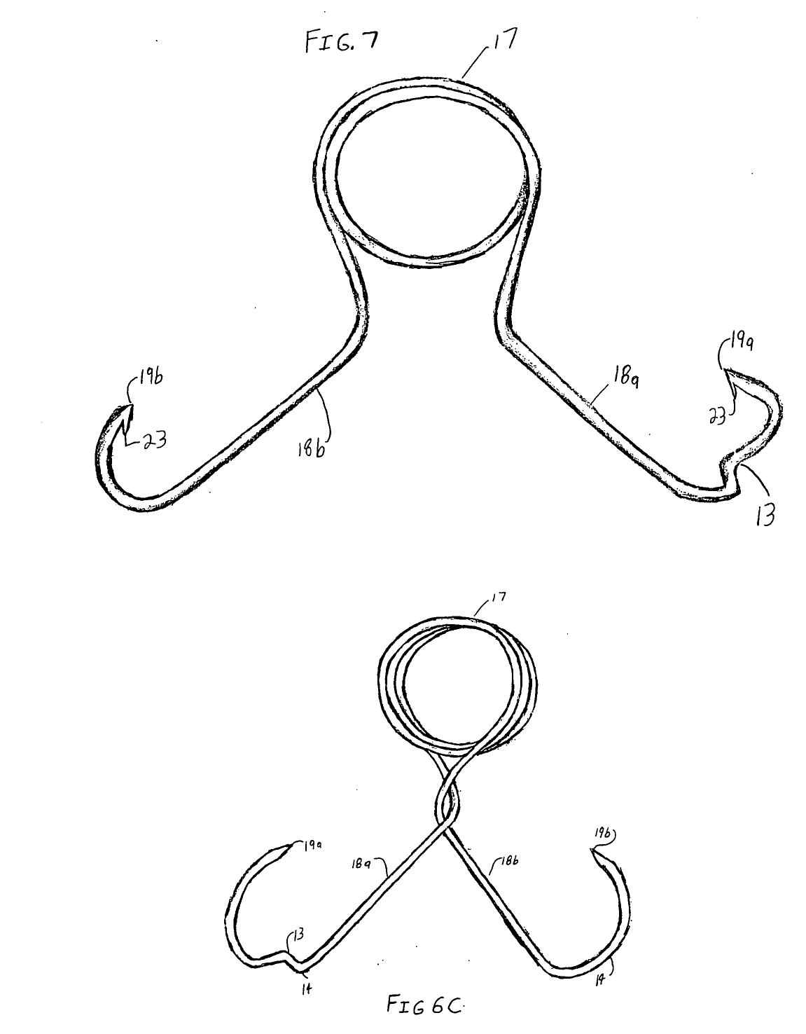

The single wire hook preferably has three positions: a relaxed position (FIG. 5), a cocked position (FIG. 6), and a set position (FIG. 5). In the relaxed position, the shanks 18a, 18b depend downwardly from the intermediate coil area 17 and substantially lie in parallel planes with the hooks facing in opposite directions. The straight portion of the shanks 18a, 18b, terminate at a curved area 14. The curved area 14 terminates in points or hooks 19a, 19b. One of the shanks 18a may have an offset portion 13, preferably near the beginning of the curved section 14, such that the shank is offset from the hook portion by ninety degrees. Further, this offset 13 is preferably such that it extends over onto the area covered by the width of the coil 17. It may also be observed that another embodiment (FIG. 7) preferably has barbs 23 disposed on the end points 19a, 19b. As disclosed herein above, the hooks and or barbs can be single or can have more than one hook and/or barb 23 on each shank 18a, 18b. It should be understood, by those in the art, that the use of barbs 23 depends primarily on the type of fishing. When fishing for sport, wherein the fish is caught and released or when fish of certain size must be released, it is preferably desired to have hooks with just end points 19a, 19b and no barbs 23. When releasing a fish, the removal of a hook with a barb will tear the flesh of the fish which can accelerate the fish's death due either to the injury itself or make in a more susceptible target to other predatory fish. It will be appreciated, by those in the art that the shanks 18a and 18b may be bent in different orientations along the shanks 18a, 18b (see FIG. 7A). It should be further appreciated that the shanks 18a, 18b can also be referred to as legs, arms, straight ends, and the like.

In the cocked position (FIGS. 6-6B) the two shanks 18a, 18b are preferably crossed over such that the curved portion of one shank 18b is held by the offset portion 13 of the other shank 18a. This one piece design may be cocked by grasping the apparatus at the shanks 18a, 18b and applying a generally opposing, lateral, inward force on the shanks 18a, 18b until the curved portions 14 of each shank cross over each other and shank 18b engages the catch 13 (see FIG. 6). In the preferred method of cocking the apparatus, shank 18b crosses over the top of the inside of shank 18a. In this cocked position, the respective curved potions of the shanks 18a, 18b are preferably substantially parallel. It should be appreciated that as the shanks 18a, 18b move past one another, shank 18b appears to shorten in order to pass by and engage the catch 13. However, it needs to be understood that the shanks 18a, 18b preferably remain rigid and that all the deflection occurs in the coil area 17.

The action of cocking the apparatus preferably generates energy which becomes stored in the coil area 17. The force or stored energy, in the coil area 17, is slightly less than the force required to drive shank 18b out of engagement with the catch 13. Therefore, when the fish applies a generally opposing, lateral, inward force as supplied by the interior of the fish's mouth, onto the shanks 18a, 18b, shank 18b is driven out of engagement with the catch 13. Preferably, the disengagement occurs because the above described force, supplied by the interior of the fish's mouth, further distorts the coil 17 which causes the “short” shank (also the shank without the catch 13) or shank 18b to move beneath the catch 13. It should be appreciated that if both shanks 18a, 18b have an integral catch (see FIG. 7A) the disengagement, of the shanks and the catches will still follow the same principles and the result will still be the setting of the hook in opposite areas of the fish's mouth. When this disengagement occurs, the energy stored in the coil area 17 is released and the shanks 18a, 18b are propelled back to their original open position (FIG. 5) with the hook points 19a, 19b pointing outwardly and in opposite directions. The apparatus is now in the set position (FIG. 5). Although it seems obvious that the the open position and the set position are the same, it should be appreciated that it is possible for an embodiment, of this apparatus to mis-set (FIG. 6C). The mis-set typically occurs when the generally opposing, lateral, inward force supplied by the interior of the fish's mouth drives shank 18b off the side of catch 13 instead of the preferred direction of under catch 13. Although the mis-set does not utilize the full stored energy in the coil area 17 and thus the hook ends 19a, 19b neither strike the fish as hard nor open as far apart, this mis-set position can nonetheless still catch the fish. Therefore, it should be appreciated that although the mis-set is not a prefered embodiment of the present apparatus it is nonetheless contemplated and disclosed by the present invention and as such should neither be veiwed as a limitation of the spirit of this invention nor a way to design around the present apparatus. It should further be appreciated that other embodiments, of the present apparatus, will disclose a catch which substantially eliminates the mis-set and is set out in more detail herein below.

When the hook is set, as illustrated in FIG. 5, the hook ends 19a, 19b will preferably penetrate the soft tissue in a fish's mouth. As the fish starts to open its mouth, the hook ends 19a, 19b will preferably continue to drive and to stitch themselves into the mouth tissue. This occurs due to the open position and stiffness of the shanks 18a, 18b and the deflection of the coil area 17 allows the shanks 18a, 18b to lengthen.

After the hook has been set and subsequently removed from the fish's mouth, it can be returned to the cocked position as described herein above.

It should be appreciated that the offset portion 13 can be on either of the two shanks 18a, 18b or on both shanks 18a, 18b. It should be understood that the operation of cocking and setting of the automatic hook apparatus is substantially the same regardless of whether the offset 13 is disposed about either shank or both shanks 18a, 18b. It should further be understood that while the offset portion 13 preferably has a ninety degree offset, any offset is sufficient as long as it releasably “locks” the two shanks in the cocked position and will resist conversion to the set position (FIGS. 5) until it is engaged by a fish (i.e. during casting or reeling the hook will not set).

In the cocked position, the shanks are crossed such that the curved areas are torsionally interwoven with each other. The present apparatus is preferably set when it is triggered by the fish's mouth. Thus, in operation, while in the cocked position, the shanks 19a, 19b are tortuously loaded. When un-cocked or set, the shanks 19a, 19b are biased to move into the direction where there is less force and thus move in the direction away from the torsion load created (i.e. the hooks spring away from the coil 17 and lodge into the sides of the fish's mouth). It should be appreciated that while the present invention is disclosed and illustrated as being used for catching fish, it can also be adapted to catching various aquatic life as well as catching/trapping other animals.

Referring again to FIG. 6, when the automatic hook is in a cocked position, the shanks 18a, 18b may be disposed such that points 19a, 19b are partially obscured thereby reducing the frequency in which the points 19a, 19b may become hooked on or come in direct contact with unintentional items such as algae, seaweed, trees, rocks, and the like.

Referring now to FIG. 7, an illustration of another embodiment of the present invention in an open position. FIG. 7 further illustrates barbs 23 disposed about the end points 19a, 19b along the shanks 18a, 18b. As described herein above, it should be appreciated that the barbs 23 may not be preferred when caught fish may be subsequently released due to the damage that the barbs will do to the fish's mouth during removal. It should be further appreciated, by those in the art, that the use of barbs, on an automatically setting hook assembly preferably requires much more care and attention to avoid unintentional impalement, of the fisherman's hands or other body parts, onto the barbs 23.

FIG. 7B further illustrates the embodiment of FIG. 7 but in the cocked position; further illustrating, among other things, that the ends 19a, 19b and the barbs 23 are partially obscured by the shanks 18a, 18b. FIG. 7A illustrates an example of one possible alternative latching apparatus. In this embodiment, the offset 41 is not setoff at ninety degrees but is disposed about both shanks 18a, 18b. It should be noted that analogous elements corresponding to the elements of FIG. 7 are designated with the prefix “1”.

FIG. 7C illustrates an embodiment, of the automatic hook assembly, wherein a different catch 15 is disposed about at least one of the shanks 18a, 18b. Catch 15 will preferably be integral to the shank or shanks about which it is disposed and be somewhat “z” shaped. When cocking the present automatic hook assembly, the shank without the “z” shaped catch 15 (designated here for simplicity of understanding with the numeral 18d) will preferably be forced under the shank with the catch 15 (designated here for simplicity of understanding with the numeral 18e). It should be understood, as described herein above, that when cocking the present embodiment, the shank 18d being forced under the catch 15 does not bend. However, the “shortening” of such shank 18d, to allow its movement under the catch 15, is preferably accomplished through the deflection of the coil 17. Preferably, after the shank 18d passes under the catch 15, the automatic hook is cocked. As described herein above, the cocking action stores energy in the coil area 17 thus providing for the outward force of the shanks 18d, 18e as the stored energy, in the coil area 17 is released when the automatic setting hook apparatus is set. It should be appreciated that the catch 15, preferably due to its shape will substantially prevent the automatic setting hook apparatus from mis-setting (FIG. 6C).

Referring now to FIG. 8, an illustration of an embodiment of the present invention, with the automatic hook in the set position, at use in an aquatic environment. The embodiment of FIG. 8 has a body 25 over the apparatus and is attached to line 16. Line 16 may be any available line such as string, a fishing line, a composite material, or a similar structure available to let out and bring in the body 25 and anything which sets the automatic hook apparatus. When the automatic apparatus is released or set (as illustrated), the barbs 23 may be exposed. Slats or openings may be along body 25 such that points 19a, 19b and the barbs 23 may become exposed upon the application of two opposing forces generally in direction of one another. Preferably the application of this force is by a fish's mouth. It should be noted that the body 25 or other similar structures can be used with most of the embodiments described herein including, but not limited to, hooks without barbs and the various catch embodiments. It should further be appreciated that instead of a body type structure, the automatic setting hook apparatus can be baited with a variety of baits including, but not limited to, live baits, worms, plastic worms, various plastic baits, and the like.

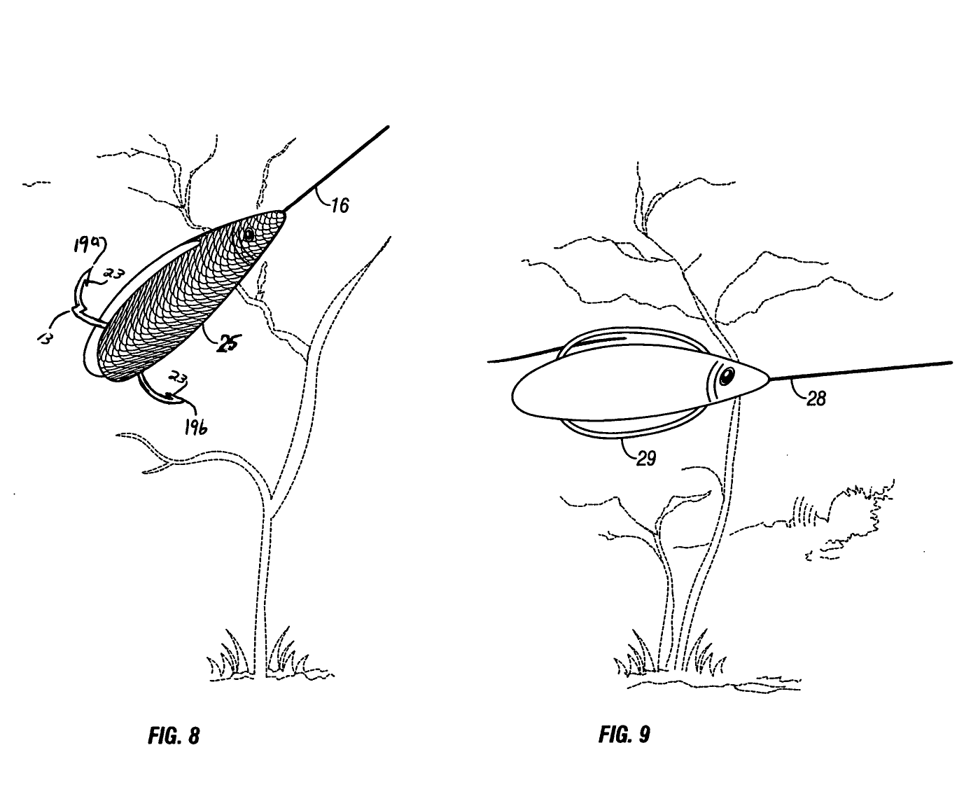

Referring now to FIG. 9, an illustration of cocked embodiment of the present invention at use in an aquatic environment. Because of the cocked position, the hook ends 19a, 19b, of the automatic hook apparatus, are at least partially obscured by the crossed shanks and further obscured by a body 29. The body 29 is releasably secured to line 28. Line 28 may be any available line such as string, a fishing line, a composite material, or a similar structure available to let out and bring in the body 29 and anything which sets the automatic hook apparatus. This figure further illustrates a feature of the present apparatus wherein the hooks and/or barbs are not exposed to contact with unintentional items including, but not limited to, algae, seaweed, trees, rocks, and other obstructions.

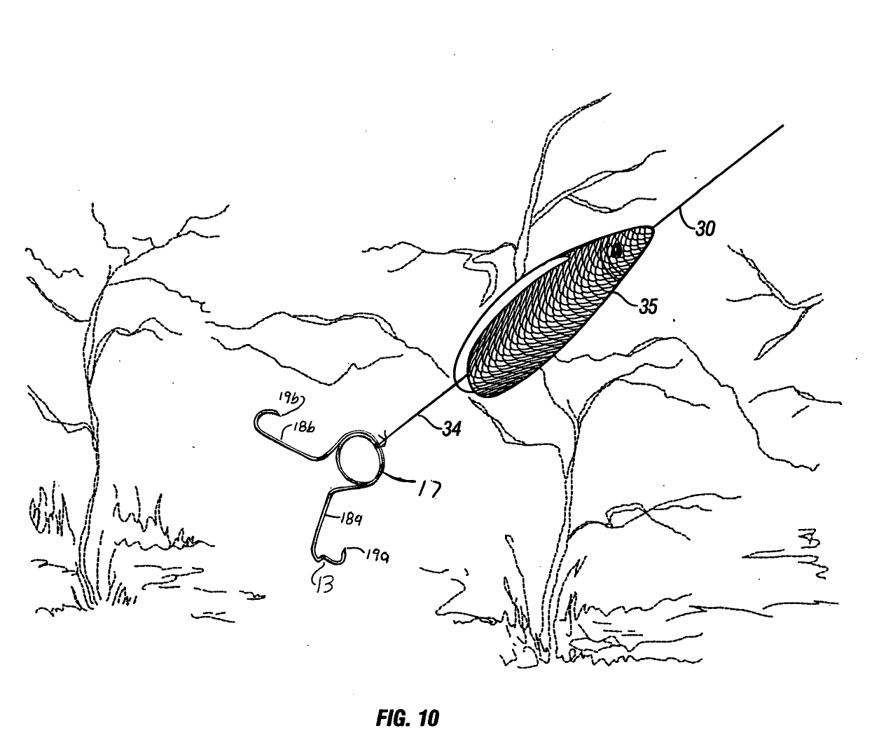

Referring now to FIG. 10, an illustration of another embodiment of the present invention at use in an aquatic environment. It may be observed that line 30 may be releasably attached to a body 35 that may be further releasably attached by a line 34 to a tensioner mechanism or coil 17. The attachment of line 30 and line 34 may be of any manner common in the art. One embodiment may utilize over-hand knots. Other knots will be readily apparent to those of skill in the art. Further, the preferred connection for a fishing line or a similar structure available to let out and bring in the automatically setting hook and anything attached to it, is to attach the fishing line to the middle coil of the coil area 17. However, other attachment positions are contemplated, by the present apparatus, and should not be viewed as a limitation herein. It will be further observed that this embodiment may be set behind the body 35. As can be seen in FIG. 10, the automatic hook is in the set position. However, it should be appreciated that when cocked, the barbs, if they are used, and the hook ends would preferably be partially obscured by the shanks and thus avoid or at least reduce the frequency in which the hook ends and or barbs, if they are utilized become hooked or in direct contact with unintentional items including, but not limited to, algae, seaweed, trees, rocks and other obstructions.

It will be readily apparent, to those of skilled in the art, that thickness of wire, hook, tensioner, and shank will affect the operation of embodiments of the present invention. Further, those skilled in the art will see that the various embodiments described herein above are only some of the configurations which can be gleaned from this disclosure. It is envisioned that the tensioner apparatus may be adjusted along shank 1a, shank 1b, point 5a and point 5b to effectuate different orientations (referring to FIGS. 1-4).

The present invention also envisions a method of use. That method of use may generally be as follows. A fisherman may attend a rod, may leave a rod unattended, or otherwise cast a line and still set a hook in a fish's mouth. In using an automatic hook assembly, opposing, lateral, inward forces are preferably applied along the hook assembly to place the automatic hook in a cocked position. Next, the fishing line, or other such structure, is preferably secured to the automatic hook assembly. Next, the fishing line is cast, preferably into a body of water, whereby the fisherman retains one end of the fishing line. After the fish uses its mouth and/or throat to cause the hook assembly to expand outwardly, or set, into the body of the fish, the fish can be retracted from the body of water.

This method preferably contemplates the use of a rod and reel during the fishing operations. This rod and reel may be used for casting out the line and reeling in the line attached to the automatic hook. Further, a body, bait, artificial or live, or other fish attracting device can be attached to or disposed about the line, disposed about the automatically setting hook assembly, or arranged in any matter believed to be beneficial to the fishing experience. However, it should be appreciated that any apparatus which allows the line or similar structure, which is connected to the automatic hook, to be cast out and retracted, can be used in the fishing operation or any other operation designed to capture or trap a target using the automatic hook. Various other methods and apparatuses are within the scope of this invention and will be apparent to those of ordinary skill in the art.

It may be seen from the preceding description that a novel automatic fish hook has been provided. Although very specific examples have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An improved automatic fish hook apparatus formed from a single wire comprising:
a first shank having a distal end;
a second shank having a distal end;
a tensioner disposed intermediate said first shank and said second shank at about the middle of said single piece of wire; and
a catch, integral to said first shank, comprising an offset disposed about said first shank, and releasably in communication with said second shank,
wherein
said first shank and said second shank having a first state and a second state, said first state disposing said first shank and said second shank in substantially parallel planes and said second state disposing said first shank and said second shank crossed, whereby
in said first state, said first shank and said second shank depend down from said tensioner,
and whereby
said catch maintains said first shank and said second shank in said second state wherein said distal end of said first shank being at least partially obscured by said second shank and said distal end of said second shank being at least partially obscured by said first shank by crossing said distal ends of the respective shanks,
and further whereby
upon the application of two generally opposing forces, applied about said first shank and said second shank, said first shank and said second shank are released into said first state.

2. The improved fish hook of claim 1, whereby in said first state, said respective distal ends, of said first shank and said second shank, being positioned in opposing directions.

3. The improved fish hook of claim 1, wherein said first shank comprises a first hook having a distal end.

4. The improved fish hook of claim 3, wherein said first hook further comprises a barb disposed about said distal end of said first hook.

5. The improved fish hook of claim 1, wherein said second shank comprises a second hook having a distal end.

6. The improved fish hook of claim 5, wherein said second hook further comprises a barb disposed about said distal end of said second hook.

7. The improved fish hook of claim 1, wherein said tensioner comprises a spring.

8. The improved fish hook of claim 1, wherein said tensioner comprises a coil.

9. The improved fish hook of claim 1, wherein said tensioner comprises one or more coils of said single wire.

10. The improved fish hook of claim 1, further comprising a prong along each of said first shank and said second shank.

11. The improved fish hook of claim 1, further comprising an eyelet disposed about and intermediate said first shank and said second shank.

12. The improved fish hook of claim 1, wherein said single wire comprises a metal.

13. The improved fish hook of claim 12, wherein said metal is selected from the group consisting of steel, iron, aluminum, copper, an alloy of steel, an alloy of iron, an alloy of aluminum, an alloy of copper and combinations thereof.

14. The improved fish hook of claim 1, wherein said single wire comprises a composite material.

15. An improved releasably biasable apparatus formed from a single piece of wire comprising:
a first shank having a distal end;
a second shank having a distal;
a tensioner disposed intermediate said first shank and said second shank at about the middle of said single piece of wire; and
a catch, integral to said first shank, comprising an offset disposed about said first shank, and releasably in communication with said second shank,
wherein
said first shank and said second shank having a first state, a second state, and a third state, said first state disposing said first shank and said second shank in substantially parallel planes, said second state disposing said first shank and said second shank crossed, and said third state disposing said first shank and said second shank crossed twice,
whereby
in said first state, said first shank and said second shank depend down from said tensioner,
and whereby
said catch maintains said first shank and said second shank in said second state wherein said distal end of said first shank is at least partially obscured by said second shank and said distal end of said second shank is at least partially obscured by said first shank by crossing said distal ends of the respective shanks,
and further whereby
upon the application of two generally opposing forces, applied about said first shank and said second shank, said first shank and said second shank are released into said first state, whereby in said first state, said first shank and said second shank depend down from said tensioner and are in substantially parallel planes and with said respective distal ends being positioned in opposing directions.

16. The improved fish hook of claim 15, wherein said first shank and said second shank being released into said third state upon the application of two generally opposing forces applied about said first shank and said second shank.

17. An improved automatic fish hook apparatus formed from a single wire comprising:
a first shank and a second shank, each having a distal end, and together having a first state and a second state, said first state disposes said first shank and said second shank in substantially parallel planes and depending down from a tensioner and said second state disposes said first shank and said second shank crossed;
said tensioner being disposed intermediate said first shank and said second shank at about the middle of said single piece of wire; and
a catch, integral to said first shank, comprising an offset disposed about said first shank, and releasably in communication with said second shank,
wherein
said catch maintains said first shank and said second shank in said second state whereby said distal end of said first shank is at least partially obscured by said second shank and said distal end of said second shank is at least partially obscured by said first shank by crossing said distal ends of the respective shanks,
and further wherein upon the application of two generally opposing forces, applied about said first shank and said second shank, said first shank and said second shank are released into said first state, whereby in said first state, said first shank and said second shank depend down from said tensioner and are in substantially parallel planes and with said respective distal ends being positioned in opposing directions.

18. The improved fish hook of claim 17, wherein said first shank comprises a first hook having a distal end and wherein said second shank comprises a second hook having a distal end.

19. The improved fish hook of claim 18, wherein said first shank comprises a first hook having a distal end and wherein said second shank comprises a second hook having a distal end and further wherein said respective distal ends, of said first hook and said second hook, each having a barb disposed about said distal ends.
